(19) United States
(12) Patent Application Publication
(10) Pub. No.: US 2024/0425373 A1
(43) Pub. Date: Dec. 26, 2024

(54) Fabrication Of Micro-Structured Carbon Materials With Bicontinuous Pores Via Pyrolysis Of Polymerized Bijels

(71) Applicant: The Trustees of the University of Pennsylvania, Philadelphia, PA (US)

(72) Inventors: Raymond J. Gorte, Narberth, PA (US); Daeyeon Lee, Wynnewood, PA (US); Kathleen J. Stebe, Penn Valley, PA (US); Tiancheng Wang, Philadelphia, PA (US); Renjing Huang, Philadelphia, PA (US)

(21) Appl. No.: 18/749,757

(22) Filed: Jun. 21, 2024

Related U.S. Application Data
(60) Provisional application No. 63/509,541, filed on Jun. 22, 2023.

(51) Int. Cl. C01B 32/05; B01J 21/18; B01J 35/59; B01J 35/64

(52) U.S. Cl. CPC C01B 32/05; B01J 21/18; B01J 35/59; B01J 35/653; B01J 35/657

(57) ABSTRACT

A method, comprising: with a bijel that comprises (i) a hydrophilic phase, (ii) a hydrophobic phase that comprises a polymerizable component, and (iii) a jammed nanoparticle layer having a 3-dimensional structure and being present at an interface between the hydrophilic phase and the polymerizable hydrophobic phase, polymerizing the polymerizable component so as to form a porous polymerized structure contacting the nanoparticles; and pyrolyzing the porous polymerized structure to give rise to a carbonaceous structure defining a porous carbonaceous wall that separates bicontinuous inner and outer pore phases, the porous carbonaceous wall contacting the nanoparticles. A carbonaceous material, comprising a porous carbonaceous wall that defines bicontinuous inner and outer pore phases.

### CROSS-REFERENCE TO RELATED APPLICATIONS

This application claims priority to and the benefit of U.S. Provisional Application No. 63/509,541, “Fabrication Of Micro-Structured Carbon Materials With Bicontinuous Pores Via Pyrolysis Of Polymerized Bijels” (filed Jun. 22, 2023), the entirety of which foregoing application is incorporated by reference herein for any and all purposes.

### GOVERNMENT RIGHTS

This invention was made with government support under 1720530 awarded by the National Science Foundation. The government has certain rights in the invention.

### TECHNICAL FIELD

The present disclosure relates to the field of microstructured materials and to the field of biphasic materials.

### BACKGROUND

Typically, micropatterned carbon structures are made by pyrolysis of a patterned polymer template. But because the polymer tends to shrink by up to 50% and to undergo significant deformation during pyrolysis, fabrication of micropatterned carbon materials with pre-designed size and shape can be very difficult. Accordingly, there is a long-felt need in the art for improved methods of forming micropatterned carbon structures and also for improved micropatterned carbon structures.

### SUMMARY

The extensive studies of highly ordered porous structures (e.g. inverse opal and gyroid) reveals very well their processing-structure-property relationship. However, there is a lack of effort on developing this relationship for disordered materials. Our work explores disordered bicontinuous aperiodic networks (DBANs) for materials innovation. DBANs feature at least two distinct disordered, bicontinuous phases which provide numerous modalities for interaction with fluids, electric charge, and electromagnetic waves. DBAN formation by kinetic arrest allows components with distinct functionalities to be assembled via scalable methods. Bicontinuous interfacially jammed emulsion gels (bijels), a unique class of particle-stabilized fluid-bicontinuous DBANs structures, are formed by arresting the spinodal decomposition process of two liquid phases via jamming of nanoparticles at interface. Its fast kinetics, high tunability and self-assembled nature makes it an ideal path for DBANs fabrication. However, existing methods of bijels fabrication faces the challenges of limitations on feature size, materials selection and fabrication environment. We have developed a pathway for triggering spinodal decomposition, vaporization induced phase separation (VIPs), that enables scalable fabrication of bijels under ambient condition. Furthermore, bijels with uniform submicron domain sizes are generated by combination of VIPs and STRIPs (solvent transfer induced phase separation) methods that greatly extended the potential of bijels-DBANs in various applications. Passive day time radiative cooling (PDRC) based on bijel is demonstrated as an example to show the structure-optical property of bijel DBANs. By carefully tuning the feature size and material selections of bijel, >95% reflectance in the solar spectrum and >95% emittance in the LWIR window is realized and Its cooling performance is proved in outdoor tests. Except optical properties, we have also transferred bijels geometry to carbon material by doing carbonization of the polymer phase. The resulting carbon bijels are tested as cathode material for air/metal battery.

In one aspect, the present disclosure provides a method, comprising: with a bijel that comprises (i) a hydrophilic phase, (ii) a hydrophobic phase that comprises a polymerizable component, and (iii) a jammed nanoparticle layer having a 3-dimensional structure and being present at an interface between the hydrophilic phase and the polymerizable hydrophobic phase, polymerizing the polymerizable component so as to form a porous polymerized structure contacting the nanoparticles; and pyrolyzing the porous polymerized structure to give rise to a carbonaceous structure defining a porous carbonaceous wall that separates bicontinuous inner and outer pore phases, the porous carbonaceous wall contacting the nanoparticles.

Also provided is a carbonaceous material, comprising a porous carbonaceous wall that defines bicontinuous inner and outer pore phases.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides cross-sectional SEM images of polymerized bijel before and after pyrolysis and the microvoids created by the removal of jammed silica nanoparticles

FIG. 2 illustrates an embodiment in which half of the polymerized bijel film is pyrolyzed (black) and compared with the other half (white).

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having.” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value: they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including.” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Bicontinuous interfacially jammed emulsion gels (bijels), a unique class of particle-stabilized fluid-bicontinuous structures, are formed by arresting the spinodal decomposition process of two liquid phases via jamming of nanoparticles at interface. When using monomer oil (for example 1,6-hexanediol diacrylate) as one of the two phases, this phase can be polymerized to form a porous polymer network encrusted by densely packed nanoparticles at all surfaces. This polymer phase can be further pyrolyzed to form carbon. We have developed means to produce pyrolyzed polymerized bijels at scale.

The polymerized bijel can be fabricated by co-solvent removal induced phase separation methods, including VIPs and STRIPs^{1,2}. The subsequent pyrolysis is done by heating the sample up to 900° C. for an hour. During the process, inert gases or reducing gases like hydrogen are used to increase carbon yield. Moreover, carbon source gases like methane can be used to increase carbon content: these carbon source gases will decompose and form carbon at this temperature.

Typically, micropatterned carbon structures are made by pyrolysis of a patterned polymer template. However, because the polymer tends to shrink by up to 50% and to undergo significant deformation during pyrolysis,³ fabrication of micropatterned carbon materials with pre-designed size and shape can be very difficult.

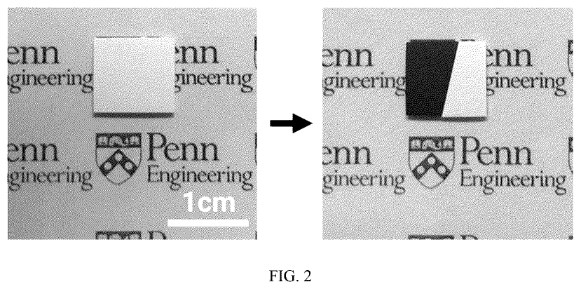

In the disclosed technology, a bijel's jammed layer of silica nanoparticles acts as a supporting scaffold that prevents macroscopic shrinkage/deformation during pyrolysis, enabling crack-free fabrication of micro-structured carbon materials with pre-designed size and shape. This is shown in FIG. 2: a polymerized bijel is cut and divided into 2 pieces. Half of the film is pyrolyzed to form carbon. The resulting carbon film is compared with the non-pyrolyzed half to show that there is no obvious shrinkage and deformation.

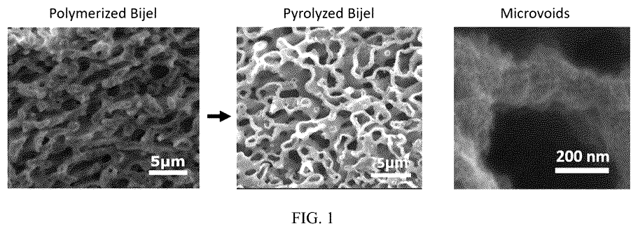

Microscopically, the shrinkage of polymer phase during pyrolysis opens the inner channel in the phase that was originally filled with polymer. The resulting structure is comprised of bicontinuous inner and outer pore phases separated by a porous carbon wall, which resembles the shape of the original jammed nanoparticle layer (FIG. 1). However, because the jammed silica nanoparticle layer does not experience any shrinkage under this temperature, it acts as a scaffold that retains the original structure. The subsequent removal of the silica nanoparticles generates high surface area microvoids (FIG. 1) that imbue the carbonized DBAN with relatively high specific area ˜700 m²/g without any activation process. Silica nanoparticles can be easily removed by dissolving them in IM NaOH solution. In our experiment, this step is done under 55° C. for overnight.

Because the scalable fabrication of bijel has been demonstrated already via STRIPs and VIPs methods, and the pore size of bijel is known to be adjustable within hundreds of nanometers to tens of microns, we have developed means to produced micro-structured carbon materials with pre-designed micro/macro features at scale. Additional information regarding bijels and bijel formation can be found in, e.g., U.S. patent application Ser. No. 15/579,086, U.S. patent application Ser. No. 17/053,943, and U.S. patent application Ser. No. 17/093,720, each of which is incorporated herein by reference in its entirety.

### Aspects

The following description is illustrative only and does not limit the scope of the present disclosure or the appended claims. It should be understood that the present technology can include any combination of any of the following features.

The disclosed technology includes methods, comprising: with a bijel that comprises (i) a hydrophilic phase, (ii) a hydrophobic phase that comprises a polymerizable component, and (iii) a jammed nanoparticle layer having a 3-dimensional structure and being present at an interface between the hydrophilic phase and the polymerizable hydrophobic phase, polymerizing the polymerizable component so as to form a porous polymerized structure contacting the nanoparticles; and pyrolyzing the porous polymerized structure to give rise to a carbonaceous structure defining a porous carbonaceous wall that separates bicontinuous inner and outer pore phases, the porous carbonaceous wall contacting the nanoparticles.

One can remove the at least some of nanoparticles so as to expose microvoids on a surface of the porous carbonaceous wall. A microvoid can have a cross-sectional dimension in the range of the cross-sectional dimension of the nanoparticles, e.g., from about 5 to about 50 nm in some embodiments. As an example, a nanoparticle having a diameter of 25 nm can leave behind a microvoid having a diameter of about 25 nm.

Removing the nanoparticles can be effected by at least partially dissolving the nanoparticles. This can be accomplished by, e.g., using a solvent that selectively dissolves the nanoparticles.

The porous polymerized structure can have a 3-dimensional structure that conforms to the 3-dimensional structure of the jammed nanoparticle layer (of the bijel), and the carbonaceous structure can define a 3-dimensional structure that substantially conforms to the 3-dimensional structure of the porous polymerized structure.

A carbonaceous structure can be substantially free of cracks. As an example, a carbonaceous structure according to the present disclosure can have less than 1 crack per mm².

The polymerizable component can, for example, comprise any one or more of 1,6-hexanediol diacrylate, 2,6-dimethyl-4-vinyl-pyridine, 2-ethylhexyl acrylate and vinyl cyclohexene. 1,6-hexanediol diacrylate is considered particularly suitable, but other polymerizable components can be used.

The polymerizing can further comprise comprises crosslinking. The crosslinking can be accomplished using methods and materials known in the field. Cross-linking, however, is not a requirement.

The pyrolyzing can be performed in the presence of a carbon-containing gas. The carbon-containing gas can include, e.g., any one or more of methane, propane, toluene, and helium. The carbon-containing gas can contain up to, e.g., about 91 wt % carbon. For example, the carbon-containing gas can include, from about 1 to about 90 wt % carbon, from about 10 to about 85 wt % carbon, from about 20 to about 75 wt % carbon, from about 25 to about 65 wt % carbon, from about 35 to about 55 wt % carbon, or even from about 40 to about 50 wt % carbon.

The carbonaceous structure can have a surface area of up to about 700 m²/g. For example, the surface area can be from about 50 to about 700 m²/g, from about 100 to about 600 m²/g, from about 200 to about 500 m²/g, or even from about 300 to about 400 m²/g.

A variety of nanoparticles can be used. For example, nanoparticles can comprise silica nanoparticles, titania nanoparticles, or any combination thereof. Nanoparticles can comprise catalytic materials (e.g., metals) thereon or therein: nanoparticles can also themselves be catalytic in nature.

The porous carbonaceous wall of the disclosed carbonaceous structures can define pores extending therethrough. Such pores can have diameters in the nanometer range, e.g., from about 1 to about 50 nm, from about 3 to about 45 nm, from about 7 to about 39 nm, from about 13 to about 31 nm, from about 16 to about 27 nm, or even from about 20 to about 24 nm.

The inner pore phase of the porous carbonaceous wall can comprise pores. The pores can have a cross-sectional dimension in the range of, e.g., from about 200 nm to about 1 μm, such as from about 200 nm to about 1 μm, from about 300 nm to about 850 nm, from about 400 nm to about 750 nm, from about 500 to about 650 nm.

The outer pore phase of the porous carbonaceous wall can comprise pores. Such pores can have a cross-sectional dimension in the range of from about 500 nm to about 2 μm, such as from 600 nm to about 1750 nm, from about 900 to about 1250 nm.

The disclosed technology also includes a carbonaceous material, comprising a porous carbonaceous wall that defines bicontinuous inner and outer pore phases.

The carbonaceous material can include a plurality of microvoids formed in a surface of the porous carbonaceous wall. Without being bound to any particular theory or embodiment, the microvoids can be characterized as craters in configuration.

In the disclosed carbonaceous materials, (a) the porous carbonaceous wall can define pores extending therethrough, (b) the inner pore phase of the porous carbonaceous wall can comprises pores having a cross-sectional dimension in the range of from about 200 nm to about 1 μm, (c) the outer pore phase of the porous carbonaceous wall can comprise pores having a cross-sectional dimension in the range of from about 500 nm to about 2 μm, or (d) any two or more of (a), (b), and (c).

The carbonaceous material can further comprise a plurality of nanoparticles contacting the porous carbonaceous wall. Such nanoparticles can be, e.g., silica, titania, and the like. A nanoparticle can have a diameter of, e.g., from about 5 to about 50 nm in some embodiments.

The carbonaceous material can comprise a catalyst and/or also be comprised in a membrane. A membrane can include an amount of the disclosed carbonaceous material: a membrane can also include a binder or other materials.

What is claimed:

1. A method, comprising:
with a bijel that comprises (i) a hydrophilic phase, (ii) a hydrophobic phase that comprises a polymerizable component, and (iii) a jammed nanoparticle layer having a 3-dimensional structure and being present at an interface between the hydrophilic phase and the polymerizable hydrophobic phase,
polymerizing the polymerizable component so as to form a porous polymerized structure contacting the nanoparticles; and
pyrolyzing the porous polymerized structure to give rise to a carbonaceous structure defining a porous carbonaceous wall that separates bicontinuous inner and outer pore phases, the porous carbonaceous wall contacting the nanoparticles.

2. The method of claim 1, further comprising removing the nanoparticles so as to expose microvoids on a surface of the porous carbonaceous wall.

3. The method of claim 2, wherein the removing is effected by at least partially dissolving the nanoparticles.

4. The method of claim 1, wherein the porous polymerized structure has a 3-dimensional structure that conforms to the 3-dimensional structure of the jammed nanoparticle layer, and wherein the carbonaceous structure defines a 3-dimensional structure that substantially conforms to the 3-dimensional structure of the porous polymerized structure.

5. The method of claim 1, wherein the carbonaceous structure is substantially free of cracks.

6. The method of claim 1, wherein the polymerizable component comprises any one or more of 1,6-hexanediol diacrylate, 2,6-dimethyl-4-vinyl-pyridine, 2-Ethylhexyl acrylate and vinyl cyclohexene.

7. The method of claim 1, wherein the polymerizing further comprises crosslinking.

8. The method of claim 1, wherein the pyrolyzing is performed in the presence of a carbon-containing gas.

9. The method of claim 8, wherein the carbon-containing gas comprises any one or more of methane, propane, toluene, and helium.

10. The method of claim 9, wherein the carbon-containing gas contains up to about 91 wt % carbon.

11. The method of claim 1, wherein the carbonaceous structure has a surface area of up to about 700 m²/g.

12. The method of claim 1, wherein the nanoparticles comprise silica nanoparticles, titania nanoparticles, or any combination thereof.

13. The method of claim 1, wherein the porous carbonaceous wall defines pores extending therethrough.

14. The method of claim 1, wherein the inner pore phase of the porous carbonaceous wall comprises pores having a cross-sectional dimension in the range of from about 200 nm to about 1 μm.

15. The method of claim 1, wherein the outer pore phase of the porous carbonaceous wall comprises pores having a cross-sectional dimension in the range of from about 500 nm to about 2 μm.

16. A carbonaceous material, comprising a porous carbonaceous wall that defines bicontinuous inner and outer pore phases.

17. The carbonaceous material of claim 16, further comprising a plurality of microvoids formed in a surface of the porous carbonaceous wall.

18. The carbonaceous material of claim 16, wherein
(a) the porous carbonaceous wall defines pores extending therethrough,
(b) the inner pore phase of the porous carbonaceous wall comprises pores having a cross-sectional dimension in the range of from about 200 nm to about 1 μm,
(c) the outer pore phase of the porous carbonaceous wall comprises pores having a cross-sectional dimension in the range of from about 500 nm to about 2 μm, or
(d) any two or more of (a), (b), and (c).

19. The carbonaceous material of claim 16, further comprising a plurality of nanoparticles contacting the porous carbonaceous wall.

20. The carbonaceous material of claim 16, wherein the carbonaceous material comprises a catalyst, wherein the carbonaceous material is comprised in a membrane, or both.
